(19) United States
(12) Patent Application Publication
(10) Pub. No.: US 2003/0115461 A1
(43) Pub. Date: Jun. 19, 2003

(54) System and method for the signing and authentication of configuration settings using electronic signatures

(76) Inventor: Mark O'Neill, Dublin (IE)

Correspondence Address: John W. Hayes, Lee, Mann, Smith, McWilliams. Sweeney & Ohlson, P.O. Box 2786, Chicago, IL, 60690-2786, US

(21) Appl. No.: 10/047,953

(22) Filed: Jan. 15, 2002

(30) Foreign Application Priority Data
Dec. 14, 2001 (EP) 01650149.6

(51) Int. Cl. H04L 9/00

(52) U.S. Cl. 713/170

(57) ABSTRACT

A method and system for improving the security associated with configuration files is disclosed. By associating an electronic signature with the configuration file it is possible to verify the privilege of a person either editing a configuration file, or on retrieval of the file prior to processing it is possible to ensure that the settings being implemented were implemented by a verified user.

### FIELD OF THE INVENTION

The invention relates to configuration settings and in particular to a method of authenticating the validity of any changes or updates to an electronic document which contains configuration settings. More particularly, the present invention relates to a method and system adapted to secure a configuration file. Within the present specification the terms “configuration file” and “configuration settings” refer to any electronic document or instructions contained within that document which relate to how a computer program or system should operate, and are the means by which a program is controlled and directed. It will be appreciated that within this specification that the term “electronic signature” refers to any signature process including symmetric and asymmetric signatures, whereas the term “digital signature” typically refers to an asymmetric signature.

### BACKGROUND TO THE INVENTION

Within computer software architecture, configuration files are used for maintaining technical and administrative control of software applications. It is usual for specific operating systems and specific software applications to have individual configuration files. The running or execution of these files determines how the system interacts with other systems, the permissible behaviour and actions of users on the system and the general operation of the system. These files may be located on the computer file system or may be located in a database.

FIG. 1 shows an example of such a flow system wherein the user of a computer program system or program 100 can create or update configuration information 110. The configuration information is stored and then retrievable or referenced by the computer program or system 120 on demand. Due to the overall importance of the configuration files to the operation of the system, the edits of such files must be auditable. This is typically achieved through the use of proprietary lists of archival information. Hereintobefore configuration files were trusted because of their location in a proprietary database or file system, or because of their format. The creation and update of these configuration files was not recorded in a manner that was cryptographically secure.

There, therefore, exists a need for a method of maintaining control over configuration files which enables an historic monitoring of the update activity of the files and also a method that improves the security and integrity to updating of such files.

### OBJECT OF THE INVENTION

It is an object of the present invention to provide an improved security method for the creation and amendment of configuration files of a computer system or program.

### SUMMARY OF THE INVENTION

Accordingly the present invention provides a method for the use of electronic signatures to ensure the integrity of configuration files, and to associate the identity of a signer with the configuration file which has been signed.

In one embodiment of the present invention a method is provided for signing configuration settings, the method comprising the steps of:

enabling a user to create a configuration file, the configuration file having a series of configuration settings contained there,

storing the configuration file, and wherein the creation of the configuration file effects the association of a electronic signature with the configuration file, the electronic signature being uniquely identifiable with the user who created the file.

The creation of a configuration file may comprise the editing of a pre-existing configuration file or the creation of a new configuration file.

The electronic signature may be incorporated with the document which it signs or may be referenced by the document.

The invention may additionally provide a method of authenticating the validity of any changes or updates to an electronic document which contains configuration settings, the method comprising the steps of:

associating a configuration file with an electronic signature, and

referencing the configuration file, the referencing of the configuration file being effected to retrieve instructions as to how a specific task should be conducted and, the referencing of the configuration file comprising the steps of:

verifying the electronic signature associated with the configuration file and, once verified, allowing a use of the configuration settings stored within the configuration file.

If the verification fails, the method desirably is adapted to disable use of the configuration settings stored within the configuration file.

The method may additionally comprise the step of authenticating a digital certificate associated with the electronic signature.

The method is further adapted to associate a digital signature of any subsequent user who edits the configuration file with the later stored configuration file.

By using an electronic signature associated with the last edit of the configuration file the present invention ensures the integrity of the settings contained within the configuration file. Any changing of data associated with or stored within the configuration file requires an association of the signature of the person who has effected the change within the configuration file. If the file has been changed, the electronic signature associated with the file becomes invalid, and this change will be detected on authentication.

In a preferred embodiment the electronic signature is an asymmetric type digital signature formed from a set of keys. In other embodiments the electronic signature is a symmetric type signature.

The invention also provides a computer system adapted to provide an improved security of configuration files, the system comprising:

a input/output module adapted to receive instructions from a user and furnish a response to those instructions,

a processor adapted to effect the processing of instructions contained within a configuration file,

a datastore adapted to store a configuration document during periods when the configuration information is not required,

a file system memory adapted to effect a retrieval of the stored configuration document prior to processing of the configurations instructions contained within the configuration document and,

wherein the retrieval of a document from the datastore and extraction of the instructions contained within that document is effected only after verification of an electronic signature associated with that document.

The system may additionally comprises a certificate authentication means, the certificate authentication means adapted to authenticate a certificate associated with the signature.

These and other features of the present invention will be better understood with reference to the following examples and Figures.

### BRIEF DESCRIPTION OF THE DRAWINGS

FIG. 1 is a schematic of a prior art configuration wherein a configuration file is stored and used without a digital signature,

FIG. 2 is a schematic of a configuration according to the present invention wherein a digital signature is associated with the configuration file,

FIG. 3 is a schematic of a computer system according to the present invention, and

FIG. 4 is a flow chart sequence outlining the retrieval of a configuration file according to the present invention.

### DETAILED DESCRIPTION OF THE DRAWINGS

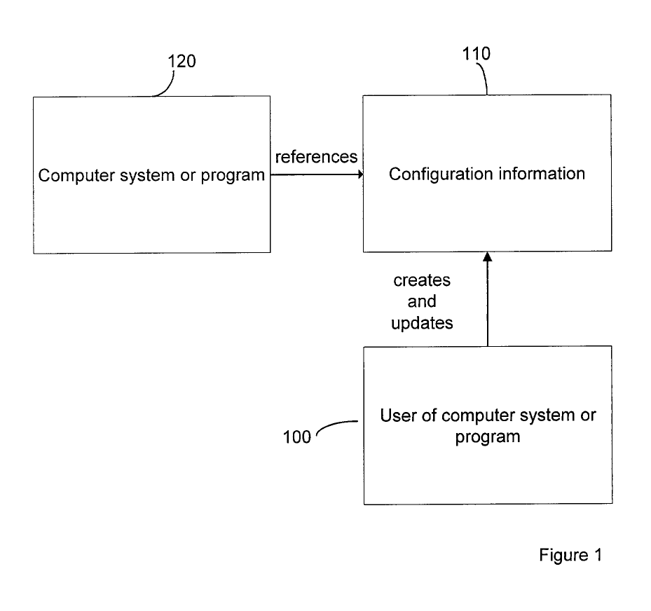

FIG. 1 has been described with reference to the prior art.

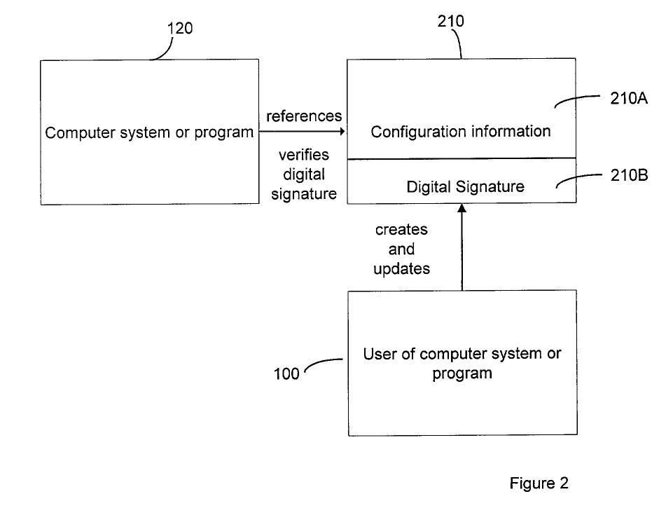

FIG. 2 shows a schematic of the present invention in accordance with a preferred embodiment, which associates a digital signature with a configuration file. The same reference numerals have been used for similar components. According to the present invention, a configuration file or document 210 comprises both configuration information 210A and a digital signature 210B of the user 100 who last edited the configuration information 210A. It will be appreciated that the digital signature does not have to be resident on the same platform or network as the document, but may be referenced by the document.

Once a configuration file has been created and stored, the information contained within the file may be referenced by a computer system or program 110 to which the information within the configuration file pertains. According to the present invention, the referencing of the information within the file 210 is not effected until the identity of the digital signature 210B associated with the configuration information 210A is verified.

The verification of the digital signature is typically effected using known principles and techniques. The following examples are illustrative of the type of techniques that may be implemented in order to effect a verification of the signature.

It will be understood that digital signature verification makes use of mathematical cryptography in order to verify the integrity of a document and to associate a signer with a signed document. The mathematics used for digital signatures is sufficiently strong to render the generation of a fraudulent signature mathematically infeasible.

In FIG. 2 above, the digital signature is verified by the computer system or application which is configured using the configuration file. This addition step, not present in the prior art shown in FIG. 1, ensures the integrity of the configuration file, meaning that there is an assurance that the document has not changed since it has been signed. In addition, the identity of the signer of the configuration file can be identified.

The following sub-sections define, at a technical level, the steps involved in digital signature verification.

1. A digest of the signed data is produced through the use of a cryptographic hashing function. A cryptographic hashing function is a one-way mathematical function which produces an output which is linked its input in such a way that an alternative input is highly unlikely to produce the same output. The output of a cryptographic hashing function is called a “hash” and it is generally shorter in length than the corresponding input. Examples of hashing algorithms include SHA-1 and MD-5. It is important that the data is hashed using the same data hashing function as that used by the sender.

2. The verifier of the digital signature uses the customer's public key to decrypt the signature and the hash.

3. If the two hashes—the hash that was encrypted by the signer and the hash produced by the recipient—are identical, then the integrity of the data is validated.

The process described in these three steps is mathematical and is independent of the Digital Certificate Processing stage described in the paragraphs below. The method of the present invention may additionally comprise the steps of processing and authenticating a digital certificate.

Digital Certificate Processing

A digital signature typically either contains or references a digital certificate that is uniquely linked to the signer. This is the means by which a person or an entity is linked to a signed document. The digital certificate contains what is termed the signer's public key. This public key is part of a key pair which consists of both a public key and a private key. These two keys are uniquely linked. The private key is used to digitally sign an electronic document, and the public key (contained in a digital certificate) is used to verify the digital signature. In both cases—signature generation and signature validation—the same underlying asymmetric key cryptography is used. The principles associated with these techniques are, as will be appreciated by the skilled person, well known and examples of the techniques may be found in U.S. Pat. No. 4,405,829, which is incorporated herein by reference.

As well as a public key, digital certificates contain information that relates to the entity to which the certificate is linked. This information may be stored in a structured format, and some digital certificates conform to a standard, X.509, for the storage of this identification information. When a digitally signed electronic document is received, the digital signature may include a digital certificate. This digital certificate may be checked for validity. A digital certificate is marked invalid if the unique relationship of the public and private key pair to the signer comes into doubt. An example of a digital certificate's validity being in doubt is a compromise of the confidentiality of a pass-phrase used to protect a private key. This means that the signer is no longer the only person who could sign documents with that private key.

In addition, a digital certificate may be invalid if the recipient does not trust the signer, or does not trust the Certificate Authority which issued their digital certificate. The sender is identified by their Digital Certificate. A Digital Certificate may contain a reference to the Certificate Authority which issued the certificate. This Certificate Authority may not be trusted by the document recipient.

A Digital Certificate may be revoked, meaning that the certificate is registered as being no longer valid, using a third party certificate store that is available over a computer network. Because of this reliance on an online certificate registry, generally implemented using the X.500 directory protocol, the certificate validation stage requires a network connection.

Validation of a digital certificate is typically performed using the following techniques:

Certificate Revocation List (CRL)

A Certificate Revocation List (CRL) is an electronic listing of invalid and revoked certificates. This list is generally stored in a hierarchical directory conforming to the X.500 standard. The list is generally checked using the LDAP (Lightweight Directory Access Protocol) protocol.

Online Certificate Status Protocol (OCSP)

OCSP is used to verify the status of a digital certificate. OCSP operates by checking multiple Certificate Revocation Lists (see above) and storing the results. The act of checking a single OCSP Responder is therefore more efficient than checking multiple Certificate Revocation Lists sequentially.

eXtensible Key Management Protocol (XKMS)

XKMS specifies protocols for distributing and registering public keys, suitable for use in conjunction with the proposed XML Signature recommendation [XML-DSIG] developed jointly by the World Wide Web Consortium (W3C) and the Internet Engineering Task Force (IETF). The XML Key Management Specification (XKMS) comprises two parts—the XML Key Information Service Specification (X-KISS) and the XML Key Registration Service Specification (X-KRSS).

The X-KISS specification defines a protocol for a Trust service that resolves public key information contained in XML signature elements, as defined by the W3C and the IETF. The X-KISS protocol allows a client of such a service to delegate part or all of the tasks required to process XML certificate details contained within X509 Certificate tags. The underlying certificate validity method may be one or other of the techniques illustrated and described above.

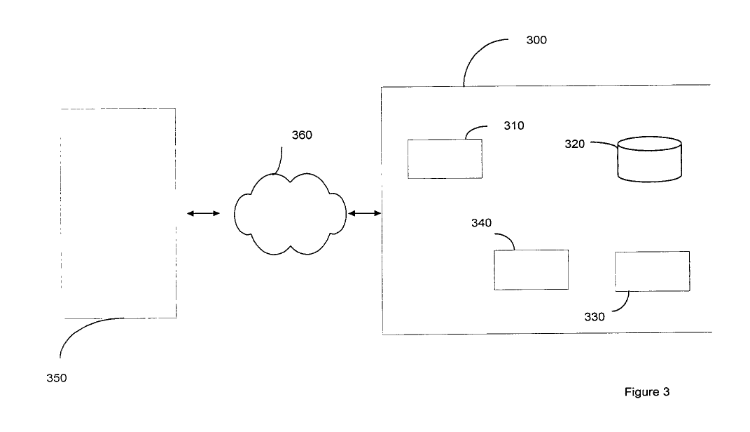

It will be appreciated that the present invention effects the storage of a configuration file as an electronic document associated with a digital signature. It will be appreciated that to effect the storage of such a file in a suitable format that the present invention provides for the permanent storage of the file in a datastore or database which then provides a copy of the configuration file during access by the referenced program or computer system to file memory. FIG. 3 shows, in schematic form, an example of such a computer architecture.

The computer system 300 comprises an input/output (I/O) 310 interface which is the communication link between the system 300 and the users or external computer systems. Typically the communication with external entities, such as an authentication engine 350 is over an internet 360 or some other equivalent communications link. A permanent data storage 320 is provided for storage of one or more configuration files which are associated or required for the operation of the computer system or programs implemented on such a system. Although the data storage or datastore 320 provides a permanent storage area for the configuration files, once they are required for reference purposes a copy of the file is extracted from the datastore 320 to a file memory 330 such as a RAM or ROM. The extraction of the system commands contained within the configuration file is only effected, in accordance with the present invention, when an associated digital signature for each file is examined and authenticated, typically in accordance with the steps outlined previously. On extraction of the configuration file and authentication of same using the authentication engine or some similar method the commands are executed using a processor 340

It will be appreciated that the authentication of a digital signature typically comprises or utilises processing power and capabilities which can effect the performance of the computer system. In one embodiment the present invention overcomes such problems by signing any variations or modifications to the configuration information all at once at the final save and not per item of change or modification. Although this results in only one signature being associated with the final edit, and not a specific signature per item of modification it will be appreciated that such an implementation achieves an efficient use of digital signature technology, which is typically processor intensive.

It will be appreciated from the above that the digital signature that requires verification prior to extraction of any configuration information is typically the signature of the person who performed the last edit of the document. This is advantageous in that the number of signatures that require verification prior to processing is minimised to that of the last edit. Any preceding signature that were associated with the configuration file or document no longer require verification. This reduces the amount of processing required prior to extraction and processing. In order to improve the audit trail of tracing those who may have edited the file or document, it will be appreciated that the number of persons or users who have authorisation to configuration document edits may be minimised. It will be appreciated that the identity of those persons who performed previous edits may typically be ascertained by use of rollback techniques to view previous versions of the configuration file.

It will also be appreciated that the present invention may provide for a verification of a signature of a user prior to allowing the user to save the edits to the configuration document, so as to ensure that the user is authorised to edit the document. The editing of the file typically requires the appending of additional steps or commands within the configuration document. The credentials of the signer can be checked using various techniques including the authentication of a certificate associated with the signer. The association of the signature and/or certificate with the saved file is used at a later stage for authentication of a retrieved document.

It will be further appreciated that the storage of the configuration files within a datastore provides for further advantages over prior art implementation where the files were stored in permanent file memory. Such advantages include the capability to archive, rollback etc., and may also enable the implementation of additional security wherein the repository or datastore is a trusted repository.

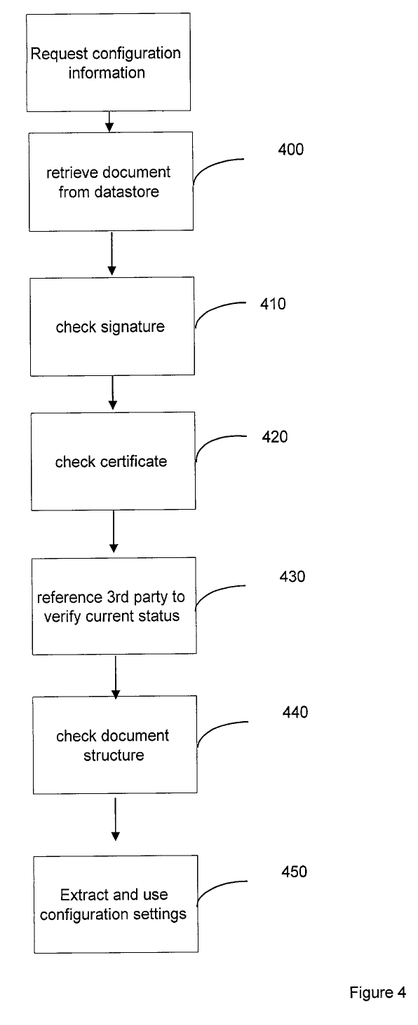

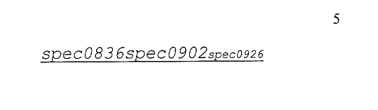

By implementing a digital signature associated with the configuration file and requiring the authentication of that signature by an external trusted third party or authentication engine 350, such as that shown in FIG. 3, the present invention provides additional confidence levels to those who implement systems according to the present invention. It will be appreciated that the authentication of the digital signature can be implemented on saving the configuration file, i.e. is the applied signature associated with the configuration file an authentic signature for that user, or simply by authenticating prior to implementation of the commands stored or referenced within the configuration file. The process flow steps shown in FIG. 4 are typically implemented on retrieval of a previously stored configuration file prior to processing of same, although it will be appreciated that not all of the steps are required for all applications or implementations.

In step 400, the configuration file is retrieved from the datastore. The signature is extracted from or identified within the file, and the signature is authenticated with regard to its integrity (Step 410). The certificate associated with the signature is then checked to ensure that the signer information is current and valid (Step 420). This may require a communication with an external authentication engine (Step 420). If the document structure is unknown a further verification may be required so as to guarantee that the structure of the document is in order for processing. (Step 430).

The present invention has been described with reference to examples of the use of digital signatures within an XML environment and the association of the signature with configuration files used in such an environment. It will be understood that the present invention is not intended to be limited by such examples except as may be necessary in view of the appended claims. By using a digital signature with a configuration file the present invention is advantageous over the prior art in many ways including the way in which the integrity of the configuration file is ensured because if the configuration file is subject to a change then the digital signature becomes invalid.

It will be further understood that although an exemplary embodiment of the present invention has been described with reference to the application of a digital signature that any electronic signature that enables a verification of the identity of the signer may be also used.

1. A method of signing a configuration file having one or more configuration settings, the method comprising the steps of:
a) enabling a user to create a configuration file, the configuration file having a series of configuration settings contained therein,
b) storing the configuration file, and
wherein the creation of the configuration file effects the association of a electronic signature with the configuration file, the electronic signature being uniquely identifiable with the user who created the file.

2. The method as claimed in claim 1 wherein the creation of a configuration file comprises the editing of a pre-existing configuration file.

3. The method as claimed in claim 1 wherein the creation of a configuration file comprises the creation of a new configuration file.

4. The method as claimed in claim 1 wherein the electronic signature is incorporated with the document which it signs

5. The method as claimed in claim 1 wherein the electronic signature is referenced by the document which it signs.

6. The method as claimed in claim 1 wherein the electronic signature utilises an asymmetric signature type signature.

7. The method as claimed in claim 1 wherein the electronic signature utilises a symmetric signature type.

8. A method of authenticating the validity of any changes or updates to an electronic document which contains configuration settings, the method comprising the steps of:
a) associating a configuration file with an electronic signature, and
b) referencing the configuration file, the referencing of the configuration file being effected to retrieve instructions as to how a specific task should be conducted, and
c) verifying the electronic signature associated with the configuration file, and
wherein once verified, a use of the configuration settings stored within the configuration file is allowed.

9. The method as claimed in claim 8 further comprising the step of disabling use of the configuration settings stored within the configuration file if the step of verifying the electronic signature with the configuration effects a failed verification.

10. The method as claimed in claim 8 comprising the additional steps of authenticating a digital certificate associated with the electronic signature.

11. The method as claimed in claim 8 wherein the digital signature associated with the configuration file is the signature of the last user to edit the configuration file.

12. A computer system adapted to provide an improved security of configuration files, the system comprising:
a) a input/output module adapted to receive instructions from a user and furnish a response to those instructions,
b) a processor adapted to effect the processing of instructions contained within a configuration file,
c) a datastore adapted to store a configuration document during periods when the configuration information is not required,
d) a file system memory adapted to effect a retrieval of the stored configuration document prior to processing of the configurations instructions contained within the configuration document and,
wherein the retrieval of a document from the datastore and extraction of the instructions contained within that document is effected only after verification of an electronic signature associated with that document.

13. The system as claimed in claim 12 additionally comprising a certificate authentication means, the certificate authentication means adapted to authenticate a certificate associated with the signature.
